(19) United States
(12) Patent Application Publication
(10) Pub. No.: US 2006/0262874 A1
(43) Pub. Date: Nov. 23, 2006

(54) Method and apparatus for power control in a multiple antenna system

(75) Inventor: TieJun Shan, Upper Salford, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/240,252

(22) Filed: Sep. 30, 2005

Related U.S. Application Data
(60) Provisional application No. 60/681,869, filed on May 17, 2005.

(51) Int. Cl. H04L 1/02

(52) U.S. Cl. 375/267

(57) ABSTRACT

A method and apparatus for use in a CDMA-type or OFDM/OFDMA-based multi-antenna system first selects an initial set of antenna weights and multiplies the selected antenna weights by copies of a transmission signal to produce a weighted transmission signal. In an OFDM/OFDMA-based implementation, a selected set of sub-carriers are modulated with the signal copies and then weighted using the antenna weights. The weighted transmission signal is transmitted using an initial overall transmission power. If an acknowledgement is not received within a predetermined time interval, the antenna weights are adjusted and/or the sub-carriers are reselected and a modified weighted transmission signal is transmitted. The overall transmission power is maintained at a fixed value as the antenna weights and/or selected sub-carriers are adjusted and is increased only if an acknowledgment is not received after a predetermined number of weight adjustments and/or sub-carrier re-selections.

### CROSS REFERENCE TO RELATED APPLICATION

This application claims the benefit of U.S. Patent Application Ser. No. 60/681,869, filed on May 17, 2005, which is incorporated by reference as if fully set forth.

### FIELD OF INVENTION

The present invention relates to power control in wireless communication systems. More particularly, the present invention relates to a method and apparatus for Open Loop Power Control in multiple antenna communication systems.

### BACKGROUND

Power control in wireless communication systems, particularly in code division multiple access (CDMA)-type systems and in orthogonal frequency division multiplexing (OFDM)/OFDMA-based systems, is used to improve cellular capacity and signal quality by limiting receiver interference and by minimizing power consumption. Open loop power control (OLPC), for example, is utilized in a mobile communication device to set its initial transmit power to a level that is suitable for reception by a receiver. Once a communication link is established with that receiver, a closed loop power control (CLPC) scheme is used to maintain the communication link at a desired quality of service (QoS) level.

In conventional OLPC schemes, a mobile device transmits a signal to an intended base station using a predetermined initial transmit power. At the base station, the quality of the transmitted signal is measured to determine if a communication link can be established with the mobile device. In this regard, the quality of the transmitted signal is typically a measure of pathloss, interference, or signal-to-interference ratio (SIR). If the quality of the transmitted signal is suitable for establishing a communication link, the base station transmits a response signal to the mobile device indicating the same. If, however, the transmitted signal is deemed inadequate, and/or if a response signal is not received at the mobile device, the mobile device increases its transmit power, retransmits its signal, and waits for the base station response signal. Until the mobile device actually receives the response signal, the mobile device will continue to increase its transmit power by a predetermined amount at predetermined time intervals. This conventional OLPC scheme is illustrated in FIG. 1.

Referring now to FIG. 1, a graphical representation of the conventional OLPC scheme described above is shown. The illustrated scheme 100 may represent an OLPC function in a single-antenna mobile communication device (not shown) configured to operate in a CDMA, CDMA2000, UMTS (universal mobile telecommunications system), or any other wireless communication system.

In order to establish a communication link, the OLPC scheme 100 first requires a mobile device to transmit an initial transmission signal T₁ at an initial, predetermined transmit power level P_{T1}. After a predetermined time interval Δₜ, if the mobile device has not received a response signal, the transmission power P is increased by a first power increase Δ₁P, and the signal is retransmitted T₂ at an adjusted transmit power P_{T2}, wherein P_{T2} may be defined as a sum of the initial transmit power P_{T1} and the predetermined power increase Δ₁P, as indicated by Equation 1 below:
P_{T2}=P_{T1}+Δ₁P. Equation (1)
Similarly, the transmit power P_{Tn} of subsequent transmissions Tₙ may be defined generally as indicated by Equation 2 below:
P_{Tn}=P_{Tn-1}+ΣΔᵢP, Equation (2)
wherein ΔᵢP, i.e., the increase in transmit power, may be fixed, or variable.

As indicated by the OLPC scheme 100, a mobile device must continue to retransmit its transmission signal T₃, T₄, . . . T_{N} at an increased transmit power P_{T3}P_{T4} . . . P_{Tn}, until it receives a response signal, i.e., until a communication link is established. Once a communication link is established, the OPLC function 100 terminates and a CLPC function (not shown) takes over power control of the established communication link. According to this type of conventional OLPC scheme 100, mobile devices may be required to transmit communication signals at large average power levels due to, for example, prolonged moments of fading or increased multi-path. In addition, conventional OLPC schemes are only applicable to single-antenna mobile communication devices. There does not exist an OLPC scheme tailored to optimize an initial transmit power in multiple-antenna devices.

Accordingly, it is desirable to have a method and apparatus for performing open loop power control in multi-antenna devices that minimizes power consumption in wireless communication systems.

### SUMMARY

The present invention is a method and apparatus for performing open loop power control (OLPC) in multi-antenna devices that minimizes power consumption in wireless communication systems. An initial set of antenna weights is selected and multiplied by copies of a transmission signal to produce a weighted transmission signal. In an orthogonal frequency division multiplexing (OFDM)/OFDMA-based implementation, the signal copies are modulated on a selected set of sub-carriers and the sub-carriers are weighted using the selected antenna weights. The weighted transmission signal is then transmitted using an initial overall transmission power. If a satisfactory signal strength acknowledgement is not received from an intended receiver within a predetermined time interval, the antenna weights are adjusted and/or the sub-carriers are reselected, modulated, and weighted and the newly weighted transmission signal is re-transmitted. The overall transmission power is maintained at a fixed value as the antenna weights and/or selected sub-carriers are adjusted and is increased only if a satisfactory signal strength acknowledgment is not received after a predetermined number of weight adjustments.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 illustrates a graphical representation of a conventional open loop power control (OLPC) scheme;

FIG. 2 illustrates a flow diagram of an OLPC scheme in accordance with the present invention;

FIG. 3 illustrates a wireless transmit/receive unit (WTRU) configured to implement the OLPC scheme of the present invention; and

FIG. 4 illustrates a graphical representation of an OLPC scheme according to the present invention.

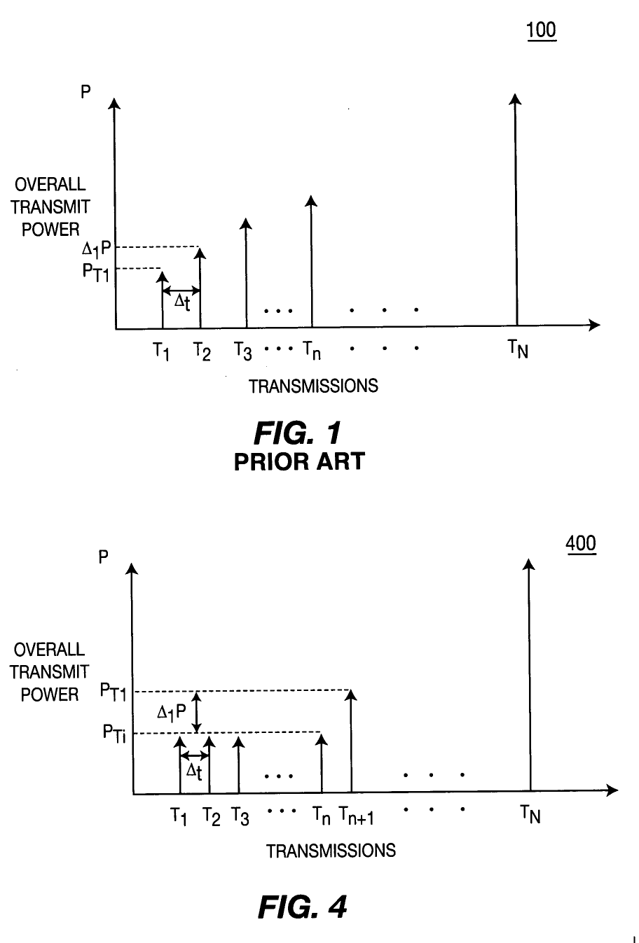

### DETAILED DESCRIPTION OF THE PREFERRED EMBODIMENT(S)

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node-B, site controller, access point or any other type of interfacing device in a wireless environment.

The present invention provides an Open Loop Power Control (OLPC) scheme and WTRU for use in multiple-antenna wireless communication systems. Contrary to conventional OLPC schemes, which are designed for use in single-antenna-type devices, the present scheme involves more than merely increasing the transmission power of a signal until that signal is successfully received at a receiver. As further discussed below, the OLPC scheme of the present invention involves adjusting various antenna weights of a transmission signal while maintaining an overall transmit power. If receipt of the transmission signal is not successfully acknowledged after a predetermined number of weight adjustments, only then will the overall transmit power be increased. Controlling the transmit power in this manner minimizes the amount of power consumed in establishing a communication link and ensures an initially lower average transmit power once the link is established.

By way of background, a multiple-antenna system, refers generally to a wireless communication system wherein at least one transmitter and/or receiver employ more than one antenna. Examples of these systems include CDMA, wideband (W)-CDMA, CDMA-one, CDMA-2000, IS95A, IS95B, IS95C, UMTS and others. OFDM/OFDMA-based systems, such as long-term evolution (LTE) 3GPP, IEEE 802.16c (Wi-Max), IEEE 802.11n are also examples of multiple-antenna systems. Two of the primary advantages of utilizing multi-antenna devices include spatial diversity and improved system throughput via spatial multiplexing.

Spatial diversity refers to an increased likelihood of successfully transmitting quality signals caused by an increased number of transmit antennas. In other words, as the number of antennas increases, the chances of successfully transmitting a quality signal increases. Spatial multiplexing refers to transmitting and receiving data streams from multiple antennas at the same time and in the same frequency spectrum. This multiplexing characteristic enables a system to achieve higher peak data rates and increased spectrum efficiency. When used in conjunction with the OLPC scheme of the present invention, spatial diversity and spatial multiplexing can be utilized to minimize power consumption, thereby further improving system capacity, performance, and throughput.

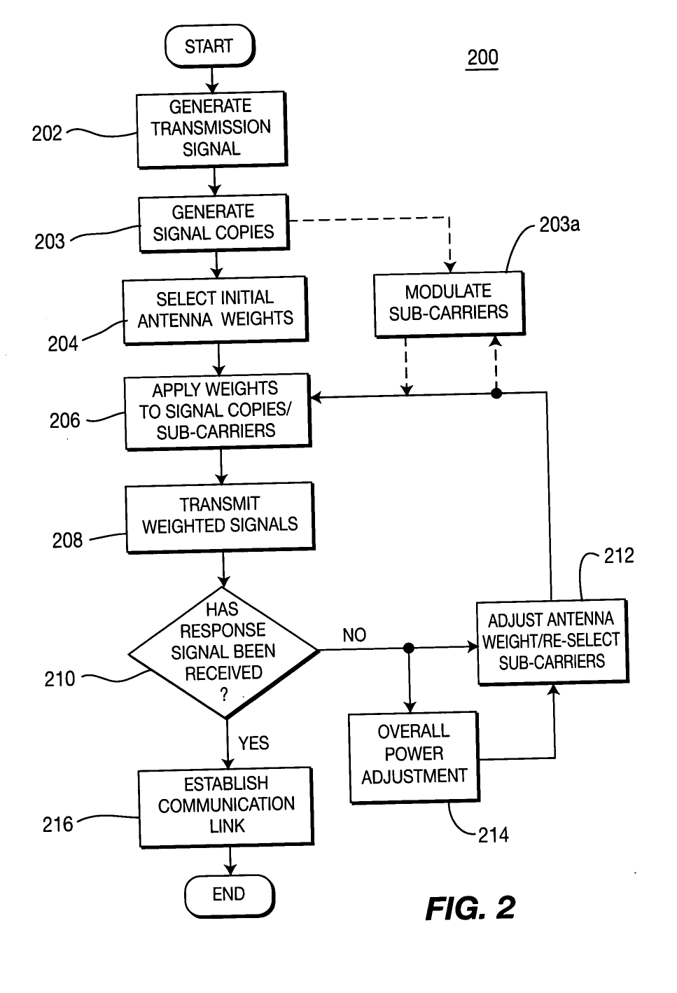

Referring now to FIG. 2, a flow diagram 200 illustrating a method for implementing OLPC in accordance with the present invention is shown. Open loop power control is initiated when a signal is generated for purposes of establishing a communication link (step 202). Copies of this signal are then generated (step 203), such as with a serial to parallel converter. In the case of an OFDM/OFDMA-based system, including single carrier FDMA (S-FDMA), these signal copies are modulated onto a plurality of selected sub-carriers (step 203a). An initial set of antenna weights is then selected (step 204) for application to the signal copies and/or the modulated sub-carriers. Next, the signal copies and/or sub-carriers are multiplied by the selected antenna weights to produce a weighted signal (step 206).

Applying antenna weights or “weighting” refers to the process of modifying particular transmit parameters, (e.g., phase, amplitude, etc.), of particular signals and/or sub-carriers before they are transmitted across multiple transmit antennas. This weighting process results in a combined signal that when transmitted, radiates the highest signal strength in the direction of a desired receiver. In the present illustration, antenna weights are applied to the initial transmission signal (step 204) to ensure reception of the signal at an intended receiver, and to maintain a desired transmit power level.

Selection of the initial antenna weights (step 204) may be accomplished by any appropriate means. Purely by way of example, the initial weights may be selected from a “code book” stored in the VWTRU. This code book may comprise, for instance, predetermined weighting permutations configured for the particular WTRU. Alternatively, the antenna weights may be selected according to a space-time coding scheme, wherein the transmitting WTRU utilizes the correlation of the fading at the various antennas to determine optimal antenna weights. Antenna weights may also be selected according to previously received channel quality indicators (CQIs). Yet another example method of determining antenna weights includes multiple-input, multiple-output (MIMO) “blind beam forming”. Blind beam forming attempts to extract unknown channel impulse responses from signals previously received via the multiple antennas. Antenna weights may then be determined based on these impulse estimates.

Referring back to FIG. 2, once the antenna weights are selected (step 204) and applied to copies of the transmission signal (step 206), the transmission signal is transmitted via the multiple antennas (step 208) with an initial overall transmit power. As used herein, “overall transmit power” refers to the total transmit power consumed in transmitting a transmission signal via multiple transmit antennas, understanding that the transmit power consumed by individual antennas may vary.

If within a predetermined time interval, a response signal is received, (step 210), a communication link is established (step 216) and the method 200 terminates. A response signal may include any type of indication, for example, a CQI, that alerts the WTRU that the weighted signal has been successfully received.

If a response signal is not received (step 210), the initial antenna weights are adjusted (step 212) and the transmission signal is re-weighted (step 206) and retransmitted (step 208). Optionally, in an OFDM-based implementation, a different set of sub-carriers may be selected for modulating with signal copies (203a) rather than, or in addition to, adjusting the initial antenna weights (step 212). It should be noted, however, that in adjusting the antenna weights and/or in re-selecting sub-carriers (step 212), the overall transmit power remains unchanged. That is to say, although adjusting antenna weights and/or re-selecting sub-carriers may result in the transmit power for a particular sub-carrier and/or a particular antenna(s) being increased, the overall transmit power of all the antennas remains the same.

After the weight adjustments and/or sub-carrier re-selection (step 212), re-application of the antenna weights (step 206), and retransmission of a weighted signal (step 208), the OLPC scheme (200) determines whether a response signal is received within the predetermined time period (step 210). If the adjusted antenna weights and/or reselected sub-carriers fail to produce a response signal, the antenna weights are readjusted and/or a new set of sub-carriers is selected (step 212), the antenna weights are applied (step 206), and the weighted signal is retransmitted (step 210). This adjustment/retransmission cycle, i.e., step 212 followed by steps 206, 208, and 210, continues until a response signal is successfully received.

If after a predetermined number of weight and/or sub-carrier adjustment/retransmission cycles, a response signal has not been received, the overall transmission power allotment is increased (step 214). Based on this higher power allotment, the antenna weights are readjusted and/or the sub-carriers are reselected (step 212) and the remainder of the OLPC scheme 200 is repeated until a communication link is established (step 216), or until the OLPC scheme 200 is otherwise terminated. It should be noted that the subsequent power increases (step 214) may be by fixed or by variable amounts.

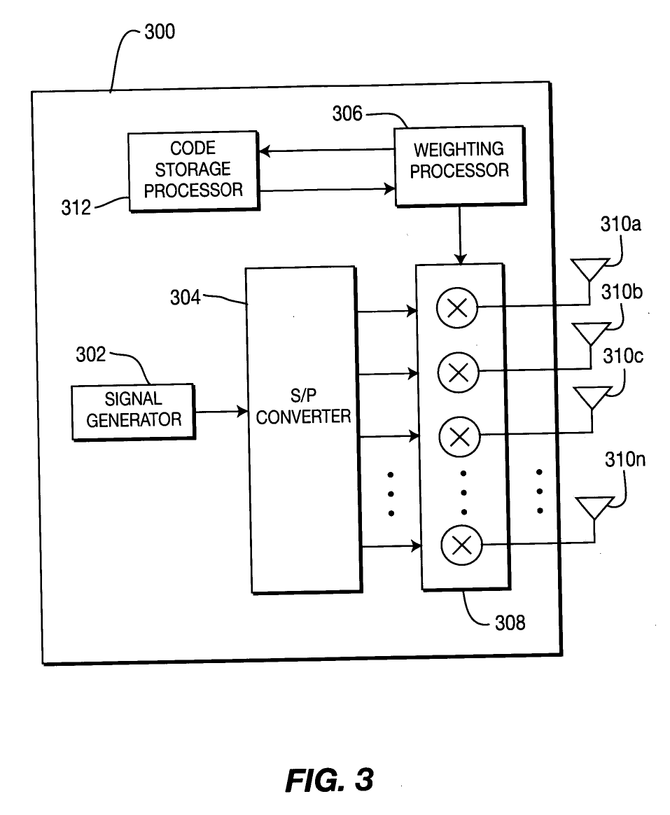

Referring now to FIG. 3, a WTRU 300 configured to implement OLPC in accordance with the present invention is shown. Included in the WTRU 300 is a signal generator 302 for generating an initial transmission signal, a serial to parallel (S/P) converter 304 for providing copies of the initial transmission signal, a weighting processor 306 for obtaining and adjusting antenna weights, including overall transmit power adjustments, a multiplier 308 for weighting the signal copies, or in the case of OFDM/OFDMA, weighting the modulated sub-carriers, using the antenna weights provided by the weighting processor 306, and a plurality of transmit/receive antennas 310a, 310b, 310c, . . . 310n, for transmitting weighted signals and for receiving response signals. Also included in the illustrated WTRU 300 is an optional code storage processor 312 for storing predetermined and/or previously utilized antenna weights.

In the WTRU 300, the signal generator 302 generates an initial transmission signal for establishing a communication link with, or example, a base station (not shown). This transmission signal is then processed in the S/P converter 304 where multiple copies of the transmission signal are generated, one copy corresponding to each of the plurality of transmit/receive antennas 310a, 310b, 310c, . . . 310n. An initial set of antenna weights are then obtained by the weighting processor 306 for application to the copies of the generated transmission signal. In this regard, the weighting processor 306 may obtain the initial set of antenna weights by any appropriate means, including from a code storage processor 312 which stores and maintains predefined and/or previously utilized antenna weights.

To illustrate, and purely by way of example, the initial set of weights may be selected according to a space-time coding scheme, wherein the weighting processor 306 is configured to utilize its awareness of the correlation of the fading of the plurality of transmit/receive antennas 310a, 310b, 310c, . . . 310n in determining optimal antenna weights. Alternatively, the weighting processor 306 may be configured to estimate optimal antenna weights based on a MIMO blind beam forming algorithm. In a preferred embodiment, the weighting processor 306 selects as the initial antenna weights, weights which have previously been generated and are stored in the optional code book processor 312.

Once the antenna weights are selected, the multiplier 308 multiplies the selected antenna weights by signal copies to produce a weighted transmission signal. In the case of an OFDM/OFDMA-based transmitter, an optional sub-carrier generator (not shown) may also be included for generating and selecting a predetermined number of sub-carriers. In such an implementation, the sub-carriers are modulated with the signal copies and then weighted by the multiplier 308 using the selected antenna weights. The weighted signal copies and/or sub-carriers are then transmitted to an intended base station (not shown) as a weighted transmission signal at a predetermined overall transmit power via the plurality of transmit/receive antennas 310a, 310b, 310c, . . . 310n. If within a predetermined time interval, the intended base station (not shown) acknowledges detection of the weighted transmission signal, a response signal is received in the WTRU 300 and a communication link is established.

If, however, receipt of the weighted transmission signal is not acknowledged, the weighting processor 306 performs a first adjustment of the initial antenna weights (i.e., phase, amplitude, and any other predetermined transmit parameters) and sends the adjustments to the multiplier 308, where they are applied to the signal copies and/or sub-carriers. Optionally or additionally, the sub-carrier generator (not shown) may reselect the sub-carriers to be used for transmission. The newly weighted signal is then retransmitted to the base station (not shown) via the plurality of transmit/receive antennas 310a, 310b, 310c, . . . 310n. It should be noted, that in adjusting the antenna weights and/or reselected sub-carriers, the overall initial transmit power remains unchanged.

If after the first antenna weight and/or sub-carrier adjustment, receipt of the weighted transmission signal is still not acknowledgment, the antenna weights are readjusted, reapplied, and the weighted transmission signal is retransmitted. Optionally or additionally, the sub-carriers set may be reselected and weighted via the current or adjusted antenna weights. This adjustment/ retransmission cycle continues until the weighted transmission signal is successfully received in the base station (not shown) and an acknowledgement reflecting the same is received in the WTRU 300. As noted above, the antenna weights are adjusted and the sub-carriers are re-selected in a manner that maintains the overall transmit power at its initial, predetermined level. In other words, the overall transmission power is normalized, preferably according to any applicable standard including CDMA-2000, CDMA-one, UMTS, WCDMA, GSM, IEEE 802.11n, IEEE 802.16e, LTE 3GPP, etc. It is only after completion of a number of adjustment cycles that the overall transmit power may be increased, as further discussed below.

After a predetermined number of weight and/or sub-carrier adjustment permutations, if receipt of the weighted transmission signal has not yet been acknowledged, the weighting processor 306 increases the overall transmission power allotment. Based on this increased power allotment, the antenna weights and/or the selected sub-carriers are readjusted, signal copies and/or sub-carriers are re-weighted, and the weighted signal is retransmitted as previously described. This new overall transmit power allotment becomes the threshold for future antenna weight and/or sub-carrier adjustments/selections until a communication link is established, or until a subsequent overall power increase is deemed necessary. It should be noted that any subsequent increases may be by a fixed amount equal to the first increase, or by a variable amount.

Once a communication link is established, i.e., once receipt of the transmission signal is acknowledged at the base station (not shown), the corresponding set of antenna weights and/or the corresponding set of sub-carriers used in generating the response is preferably stored, perhaps in the optional code storage processor 312, for use in establishing future communication links. In smart-antenna-configured WTRUs, these antenna weights/sub-carrier combinations may be utilized as an initial configuration for use in beam forming and/or in various other MIMO algorithms.

Referring now to FIG. 4, a graphical representation 400 of OLPC implemented according to the present invention is shown. The graphical representation 400 may represent an OLPC function in a multi-antenna WTRU (not shown) configured to operate in a CDMA, CDMA2000, CDMA-one, UMTS, OFDM/OFDMA, S-FDMA, IEEE 802.16e, IEEE 802.11n, LTE 3GPP, or any other multiple-antenna wireless communication system.

In order to establish a communication link, a WTRU (not shown) transmits an initial transmission signal T₁, weighted with a selected set of antenna weights, at an initial, predetermined transmit power level P_{Ti}. In an OFDM-based implementation, the weights are applied to an initial set of selected sub-carriers. If within a predetermined time interval Δₜ, the WTRU (not shown) has not received an acknowledgment confirming receipt of the weighted transmission signal T₁, the antenna weights are adjusted and/or the sub-carriers are reselected in a manner that normalizes or maintains the initial, predetermined transmit power constant. The newly adjusted antenna weights are then applied to the transmission signal T₁ and the adjusted transmission signal T₂ is retransmitted. Optionally or additionally, a new set of sub-carriers is reselected and weighted with the initial antenna weights or with the newly adjusted antenna weights.

If after this antenna weight and/or sub-carrier adjustment, receipt of the adjusted transmission signal T₂ is not acknowledged, the antenna weights and/or the selected sub-carriers are again adjusted, re-weighted and the readjusted transmission signal T₃ is retransmitted. This adjustment/ retransmission cycle continues until a communication link is established, or until a predetermined number n of adjusted signals Tₙ are transmitted and unsuccessfully acknowledged. As indicated in the graphical representation 400, although the signal transmissions T₁, T₂, . . . Tₙ are each transmitted with different antenna weight/sub-carrier combinations, they are each transmitted with the same overall initial transmit power level P_{Ti}.

After n transmissions, if a communication link has not been established, the initial transmit power level P_{Ti} is increased by a first power increase amount Δ₁P. The transmission signal Tₙ₊₁ is then retransmitted with an adjusted set of antenna weights and/or with newly selected sub-carriers with the newly adjusted overall transmit power level P_{T1}, wherein P_{T1} may be defined as a sum of the initial transmit power P_{Ti} and the predetermined power increase Δ₁P, as indicated by Equation 3 below:
P_{T1}=P_{Ti}+Δ₁P. Equation (3)
Subsequent transmissions Tₙ₊₁ . . . Tₙ₊ₙ will continue to be weight and/or sub-carrier-adjusted and transmitted at the increased power level P_{T1} until a communication link is established, or until an additional n signals are unsuccessfully transmitted, at which point the transmit power P_{T1} is increased by a second power increase amount Δ₂P. Once a communication link is established, the OPLC function terminates and a CLPC function (not shown) takes over power control of the established communication link.

It should be noted that in preferred implementations of the present invention, a three (3) to seven (7) db signal-to-noise ratio (SNR) gain may be attainable depending on channel conditions, the number of transmit antennas, and a variety of other factors. It should also be noted that to implement the present invention in a WTRU, for example, no additional hardware, other than what is typically in WTRUs, is required.

The features of the present invention may be incorporated into an IC or be configured in a circuit comprising a multitude of interconnecting components.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method of open loop power control (OLPC) for use in a multi-antenna transmitter, the method comprising:
selecting an initial set of antenna weights;
multiplying the selected antenna weights by copies of a transmission signal to produce a weighted transmission signal;
transmitting the weighted signal using an initial overall transmission power; and
adjusting the antenna weights in the transmission signal and retransmitting said transmission signal until a satisfactory signal strength acknowledgement is received from an intended receiver.

2. The method of claim 1, wherein the initial antenna weight set is selected from predetermined values stored in a code book.

3. The method of claim 1, wherein the initial antenna weight set is selected according to a space-time coding scheme.

4. The method of claim 1, wherein the initial antenna weight set is selected according to a multiple-input multiple-output (MIMO) blind beam forming algorithm.

5. The method of claim 1, wherein the initial antenna weight set is a set of weights that produced a satisfactory signal strength acknowledgment in a prior transmission.

6. The method claim 1, wherein the overall transmission power level is maintained at a fixed value as the antenna weights are adjusted.

7. The method of claim 6, further comprising increasing the overall transmission power level of the transmission signal if the satisfactory signal strength acknowledgement is not received within a predetermined number of antenna weight adjustments.

8. The method of claim 7, wherein the overall transmission power level is increased by a fixed amount.

9. The method of claim 7, wherein the overall transmission power level is increased by a variable amount.

10. The method of claim 7, wherein the transmitter is configured for use in a code division multiple access (CDMA) multiple-antenna system.

11. The method of claim 10, wherein said transmitter is a wireless transmit/receive unit (WTRU).

12. The method of claim 10, wherein said transmitter is a base station.

13. The method of claim 7, wherein the transmitter is configured for use in an orthogonal frequency division multiplex (OFDM)-based multiple-antenna system.

14. The method of claim 13, wherein the multi-antenna transmitter is an orthogonal frequency division multiple access (OFDMA) transmitter.

15. The method of claim 13, wherein the multi-antenna transmitter is a single carrier-frequency division multiple access (S-FDMA) transmitter.

16. The method of claim 13, further comprising modulating a predetermined set of sub-carriers with the signal copies and weighting said modulated sub-carriers using the selected antenna weights.

17. The method of claim 16, further comprising:
selecting an alternate set of sub-carriers;
modulating said alternate sub-carriers with the signal copies; and
weighting said modulated alternate sub-carriers using the initial antenna weights.

18. The method of claim 16, wherein the initial set of antenna weights are adjusted and the set of sub-carriers is reselected until a satisfactory signal strength acknowledgment is received.

19. The method of claim 18, wherein the signal strength acknowledgement is a predefined channel quality indicator (CQI).

20. The method of claim 19 wherein said transmitter is a wireless transmit/receive unit (WTRU).

21. The method of claim 19, wherein said transmitter is a base station.

22. A multi-antenna transmitter configured to perform OLPC in a multiple-antenna system, the transmitter comprising:
a signal generator configured to generate an initial transmission signal;
a serial to parallel (S/P) converter configured to provide copies of the initial transmission signal;
a weighting processor configured to select an initial set of antenna weights and to adjust the initial antenna weights until a satisfactory signal strength acknowledgement is received;
a multiplier configured to multiply antenna weights by copies of the transmission signal to produce a weighted transmission signal; and
a plurality of transmit/receive antennas configured to transmit the weighted transmission signal at an initial overall transmission power level and to receive signal strength acknowledgements.

23. The transmitter of claim 22, further comprising a code storage processor configured to store and maintain a code book of predetermined and previously utilized antenna weights; wherein the weighting processor is configured to select antenna weights from values stored in the code storage processor.

24. The transmitter of claim 22, wherein the weighting processor is configured to select the antenna weights according to a space-time coding scheme.

25. The transmitter of claim 22, wherein the weighting processor is configured to select the antenna weights according to a MIMO blind beam forming algorithm.

26. The transmitter of claim 22, wherein said weighting processor is configured to utilize, as the initial antenna weight set, a set of weights that produced a satisfactory signal strength acknowledgement in a prior transmission.

27. The transmitter of claim 22, wherein the transmitter is configured to maintain the initial overall transmission power level at a fixed value as the antenna weights are adjusted.

28. The transmitter of claim 27, wherein the transmitter is configured to increase the initial overall transmission power level of the weighted transmission signal if a signal strength acknowledgement is not received within a predetermined number of antenna weight adjustments.

29. The transmitter of claim 28, wherein the overall transmission power level is increased by a fixed amount.

30. The transmitter of claim 28, wherein the overall transmission power level is increased by a variable amount.

31. The transmitter of claim 28, wherein said transmitter is configured to operate in a CDMA-type multiple-antenna system.

32. The transmitter of claim 31, wherein said transmitter is a WTRU.

33. The transmitter of claim 31, wherein said transmitter is a base station.

34. The transmitter of claim 28, wherein said transmitter is configured to operate in an OFDM-based wireless communication system.

35. The transmitter of claim 34, wherein said transmitter is an OFDMA transmitter.

36. The transmitter of claim 34, wherein said transmitter is a S-FDMA transmitter.

37. The transmitter of claim 34, further comprising a sub-carrier generator configured to generate a predetermined set of sub-carriers, wherein said sub-carriers are modulated with the signal copies and wherein the multiplier is further configured to produce a weighted transmission signal by multiplying the antenna weights by the modulated sub-carriers.

38. The transmitter of claim 37, wherein the sub-carrier generator is configured to select an alternate set of sub-carriers, wherein said alternate sub-carriers are modulated with the signal copies and weighted using the initial antenna weights.

39. The transmitter of claim 38, wherein the weighting processor adjusts the initial antenna weights and the sub-carrier generator reselects a set of sub-carriers until a satisfactory signal strength acknowledgment is received.

40. The transmitter of claim 39, wherein said signal strength acknowledgement is a CQI.

41. The transmitter of claim 40, wherein said transmitter is a WTRU.

42. The transmitter of claim 40, wherein said transmitter is a base station.

43. An integrated circuit (IC) configured to perform OLPC in a multiple-antenna system, the IC comprising:
a signal generator configured to generate an initial transmission signal;
a serial to parallel (S/P) converter configured to provide copies of the initial transmission signal;
a weighting processor configured to select an initial set of antenna weights and to adjust the initial antenna weights until a satisfactory signal strength acknowledgement is received; and
a multiplier configured to multiply antenna weights by copies of the transmission signal to produce a weighted transmission signal.

44. The IC of claim 43, further comprising a code storage processor configured to store and maintain a code book of predetermined and previously utilized antenna weights; wherein the weighting processor is configured to select antenna weights from values stored in the code storage processor.

45. The IC of claim 44, wherein said IC is configured to maintain an initial overall transmission power level of a transmitter at a fixed value as the antenna weights are adjusted.

46. The IC of claim 45, wherein said IC is configured to increase the initial overall transmission power level of the weighted transmission signal if a signal strength acknowledgement is not received in the transmitter within a predetermined number of antenna weight adjustments.

47. The IC of claim 46, wherein said IC is configured to operate in a CDMA-type multiple-antenna system.

48. The IC of claim 46, wherein said IC is configured to operate in an OFDM-based wireless communication system.

49. The IC of claim 48, further comprising a sub-carrier generator configured to generate a predetermined set of sub-carriers, wherein said sub-carriers are modulated with the signal copies and wherein the multiplier is further configured to produce a weighted transmission signal by multiplying the initial antenna weights by the modulated sub-carriers.

50. The IC of claim 49, wherein the sub-carrier generator is configured to select an alternate set of sub-carriers, wherein said alternate sub-carriers are modulated with the signal copies and weighted using the initial antenna weights.

51. The transmitter of claim 50, wherein the weighting processor adjusts the initial antenna weights and the sub-carrier generator reselects a set of sub-carriers.
